(19) United States
(12) Patent Application Publication
(10) Pub. No.: US 2013/0324059 A1
(43) Pub. Date: Dec. 5, 2013

(54) WIRELESS DEVICE WITH HYBRID ENERGY CHARGING

(71) Applicant: Petari USA, Inc., Boston, MA (US)

(72) Inventors: Brian Lee, Boston, MA (US); Jamshed Dubash, Shrewsbury, MA (US); Jahangir Nakra, Titusville, NJ (US)

(21) Appl. No.: 13/906,773

(22) Filed: May 31, 2013

Related U.S. Application Data
(60) Provisional application No. 61/654,342, filed on Jun. 1, 2012.

(51) Int. Cl. H04W 52/02

(52) U.S. Cl. CPC H04W 52/02
USPC 455/127.1

(57) ABSTRACT

A hybrid energy control system comprising a first energy harvester, a second energy harvester, an energy reservoir operably connected to the first energy harvester and the second energy harvester. The hybrid energy control system is particularly suited for use in wireless RF devices, such as RF tracking devices.

### CROSS-REFERENCE TO RELATED APPLICATION

This application claims the benefit of U.S. Provisional Application No. 61/654,342 titled ARCHITECTURE AND APPARATUS FOR REMOTE CHARGING FOR M2M APPLICATIONS, filed Jun. 1, 2012, the entire contents of which are incorporated herein by reference for all purposes.

### FIELD OF THE DISCLOSURE

The present disclosure relates generally to asset tracking devices and systems. More particularly, the disclosure provides a tracking device with a regenerable energy source.

### BACKGROUND

In industry nowadays, success or failure depends in part upon knowing the up-to-date status of various assets. For example, in the freight delivery business, up-to-date knowledge of the location and, in some instances, the environment of various assets, such as pallet goods, is critical to efficient and reliable operations. Failure to maintain up-to-date status information can result in temporarily lost assets, sub-optimal use of the assets, and in the case of freight delivery, missed or late deliveries.

Recently, technologies have been developed that greatly assist in tracking locations of assets. For example, global positioning systems (GPS) use wireless signals transmitted by earth-orbiting satellites to calculate the position of a receiving device. Although relatively expensive, GPS receivers are capable of providing relatively accurate location information for virtually any point in the world.

More recently, radio frequency identification (RF or RFID) systems have been developed in which devices, often referred to as “tags,” wirelessly communicate with readers. RF tracking systems are typically used in parcel tracking and sorting, container tracking, luggage tracking, retail tracking, warehouse tracking and inventory operations. The RF tags may be either passive or active. Passive tags absorb signals transmitted by the reader and retransmit their own signals, such as identification information. While passive tags do not require a local energy source, their resulting transmit range is relatively short, typically less than 5-10 meters. In contrast, active tags, which send a signal to indicate its location, include a local energy source (such as a battery) that improves transmission range. Depending on the wireless signal system used by the device, the range may be on the order of several meters or several hundred meters. Regardless of the types of tags used, knowledge of the fixed location of the reader devices allows users to identify the location of assets that have tags attached thereto.

Active tag systems are preferred for some applications due to their long range transmission range. Unfortunately, the position signal or date “ping” drains battery life of the transmitter device, thus resulting in added operational cost of the system, due to needed recharging or replacement of the battery.

### SUMMARY

The present disclosure provides rechargeable energy sources, particularly for use with wireless transmitting devices, in a small form factor, with a universal interface and RF friendly mechanism.

Previous rechargeable batteries for wireless transmitting devices and other machine-to-machine (M2M) applications have deficiencies, due to the limited lifetime of the battery. The present disclosure provides a universal interface for multiple energy sources for a rechargeable battery, and is an energy efficient small form factor for multiple energy sources. The regenerable energy sources of this disclosure increase lifetime of the wireless devices, and are RF compatible.

One particular embodiment of this disclosure is a wireless device, such as a tracking device. The device includes a hybrid energy control system comprising a primary energy source, a secondary energy source, and an energy management controller operably connected to the primary energy source and the secondary energy source. The device further includes an RF communication module and a GPS positioning element. The primary energy source may include at least two energy harvesters and appropriate circuitry, the at least two energy harvesters harvesting the same or different energy. The energy harvesters may be a piezoelectric element, a photovoltaic cell, and/or a thermoelectric generator.

Another particular embodiment of this disclosure is a wireless device, such as a tracking device, including a hybrid energy control system comprising a first energy harvester, a second energy harvester, an energy reservoir operably connected to the first energy harvester and the second energy harvester, and an energy management controller operably connected to the first energy harvester, the second energy harvester, and to the reservoir. The device further includes an RF communication module and a GPS positioning element. The first energy harvester and the second energy harvester may be individually selected from a piezoelectric element, a photovoltaic cell, and a thermoelectric generator.

In any of the embodiments, the RF communication module can be a ZigBee and/or Low Energy BlueTooth communication module. In some embodiments, the device also includes a cellular communication module, which may be a CDMA and/or GSM communication module. Any of the embodiments of the device may include a back-up battery.

These and various other features and advantages will be apparent from a reading of the following detailed description.

### BRIEF DESCRIPTION OF THE DRAWING

The disclosure may be more completely understood in consideration of the following detailed description of various embodiments of the disclosure in connection with the accompanying drawing, in which:

FIG. 1 is a block diagram of a wireless network.

FIG. 2 is a block diagram of a hybrid energy system.

FIG. 3 is a block diagram of a universal controller interface for the energy system of FIG. 2.

FIG. 4 is a schematic block diagram of a tracking device according to this disclosure.

FIG. 5 is a schematic block diagram of another tracking device according to this disclosure.

### DISCUSSION OF THE INVENTION

Assets and products (e.g., items, objects or people) move through different paths, such as manufacturing processes and supply chains during the course of their lifetime. There is a desire to track these assets, either because of their value or merely for business justification purposes. A tracking device or system therefore is highly beneficial for solving the dilemma of knowing the physical location of the asset at a set point in time. The operation of the tracking device is dependent on the proper functioning of the energy source (e.g., battery). The present disclosure provides a wireless, active, RF tracking system that has decreased operational cost, particularly decreased battery maintenance cost, due to incorporation of multiple energy efficient small form or ultra small form factors in the energy or power control system.

Energy harvesting is a known feasible mechanism of powering potentially battery-free wireless nodes by converting local ambient energy into useable electrical energy. Ambient energy sources are present throughout the environment and can be converted into usable electrical energy by a suitable transducer, such as a thermoelectric generator (TEG) for a temperature differential, a piezoelectric element for vibration or other movement, a photovoltaic cell for sunlight (or other lighting) and even galvanic energy from moisture. These so-called “free” energy sources can be used to autonomously power electronic components and systems. With entire wireless nodes now capable of operating at microwatt average power levels, it is feasible to power them from non-traditional sources.

There is always room for improvements to current energy harvesting systems. The regenerable energy sources of this disclosure provide wireless rechargeable nodes, optionally battery-free, using an energy control system configured with multiple energy efficient small form or ultra small form factors.

In the following description, reference is made to the accompanying drawing that forms a part hereof and in which are shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

Unless otherwise indicated, all numbers expressing feature sizes, amounts, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The cost of running supply wires to a device (i.e., hardwiring the device) is often high compared to the cost of a battery, thus, in addition to the wireless freedom, there is an economic benefit to utilize a battery in a device. Although ongoing developments in energy management have enabled electronic circuits to operate longer for a given energy supply, they have their limitations due to battery life. An economic benefit can be recognized by using energy harvesting technology, because the cost of energy harvesting electronics is often lower than the routine maintenance required to replace batteries.

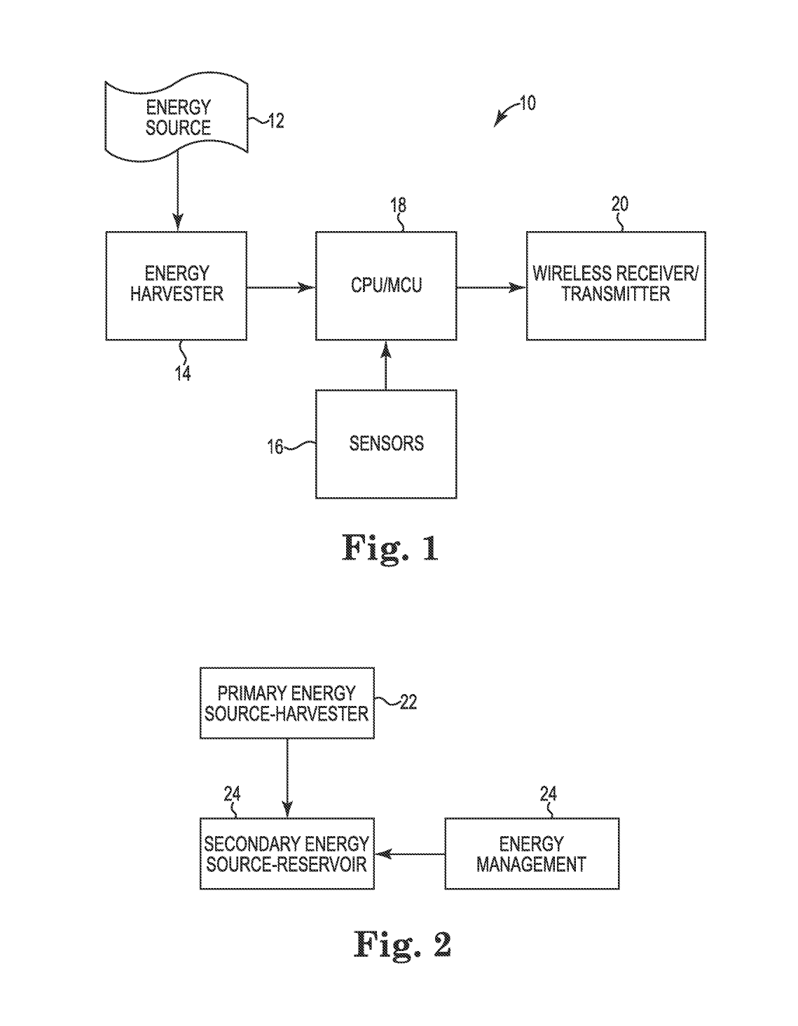

A generic energy-harvesting configuration for a wireless node is shown in FIG. 1 as system 10. Although not part of the physical system 10, an ambient energy source 12 (e.g., an ambient energy source such as UV light, vibration, etc.) provides energy to an energy harvester element 14, which converts the energy from energy source 12 to usable power. Harvester element 14 may be, for example, a transducer element or a photovoltaic cell. A power conversion circuit (not shown) may be incorporated with harvester element 14 to power downstream electronics. System 10 includes a sensing component 16 that links the node to the physical world; examples of suitable sensors for sensing component 16 include temperature sensor, humidity sensor, visible light, etc. Also present in system 10 is a computing component 18 such as a central processing unit (CPU) and that can include a microprocessor or microcontroller (MCU) that processes measurement data and stores them in memory of system 10. Also present is a communication component 20 for receiving and/or transmitting data. Communication component 20 can include a short and/or long range radio for wireless communication with neighboring nodes and/or the outside world, an RF module for communication over a RF network, and/or a cellular module for communication over a cellular network.

Summarized, system 10 utilizes energy source 12 to provide energy to power communication component 20. After the electrical energy has been identified from source 12, it is converted by appropriate circuitry in harvester element 14 and modified into a suitable form to power the downstream electronics, such as communication component 20. A microprocessor or other computing component 18 can wake up or activate any number of sensors 16 to take a reading or measurement or otherwise collect data, which can then be manipulated (for example, by an analog-to-digital converter) for transmission via communication component 20 (such as an ultra-low-power wireless transceiver).

Efforts to provide a universal interface for energy harvesters (e.g., harvester element 14) can be complicated by a variety of practical difficulties. This issue is exacerbated by the incompatibility between some wireless node devices and some energy harvesters. An energy harvester often includes different components of energy sources depending on availability of these sources. For example, a wireless node device may include an RF antenna if it receives power by RF harvesting, whereas another wireless node device may include a thermoelectric generator, and yet another wireless node device may include a piezoelectric element for vibration harvesting and/or a photovoltaic cell for sunlight (or indoor lighting). Unfortunately, issues may arise due to the interactions between the energy system and wireless node device communication systems. For example, certain energy sources can interfere or harm wireless node device communication systems (e.g., RF, cellular) in some circumstances.

The energy system of this disclosure includes a universal interface controller adapted to utilize and manage multiple energy sources, wherein the controller is capable of receiving power from a plurality of different energy sources, such as light (solar or other), RF energy, heat (thermal), vibration, and moisture. The energy control system, including each of the energy harvesting technologies, is small form factor.

Energy creation due to energy harvesting is generally subject to low, variable and unpredictable levels of available power. A hybrid structure, that interfaces a harvester and a secondary power reservoir, is shown in FIG. 2. In FIG. 2, a hybrid energy control system 22 is illustrated with a primary energy source 24 and a secondary energy source 26. An energy harvester, because of its unlimited energy supply, albeit variable, is shown as primary energy source 24 of system 22. Secondary energy source 26 provides a reservoir for energy from primary source 22, as a rechargeable battery, a super capacitor, or the like. In such a manner, secondary source 26 yields higher output by stores less energy, supplying power when required but otherwise regularly receiving charge from primary harvesting source 24. A power management circuit or controller 28 regulates the energy system 22. Thus, in situations when there is no ambient energy from which to harvest power, such as darkness in the case of a photovoltaic cell, secondary energy source 26 is used to power the wireless node. In one embodiment, secondary energy source 26 may be selectively configured to receive energy from primary energy source 24 or a second energy source (not shown), the primary and second sources being the same or different (e.g., solar versus vibrational).

A universal controller interface for multiple energy sources, such as the hybrid system 22 of

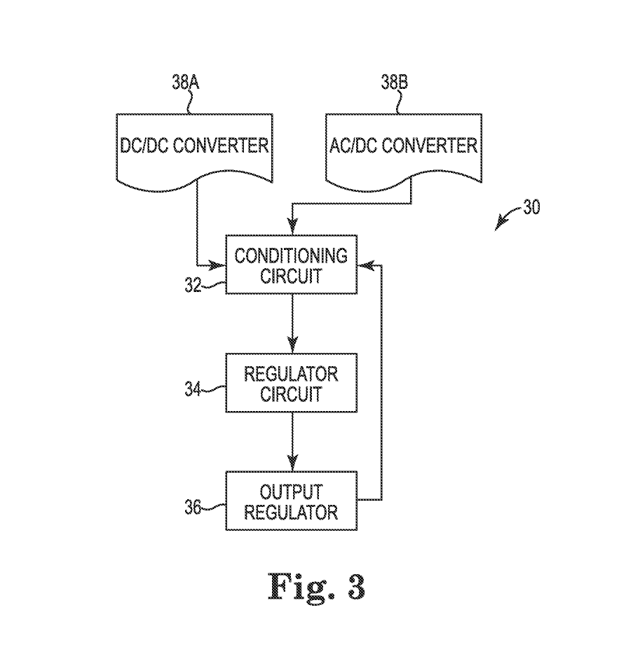

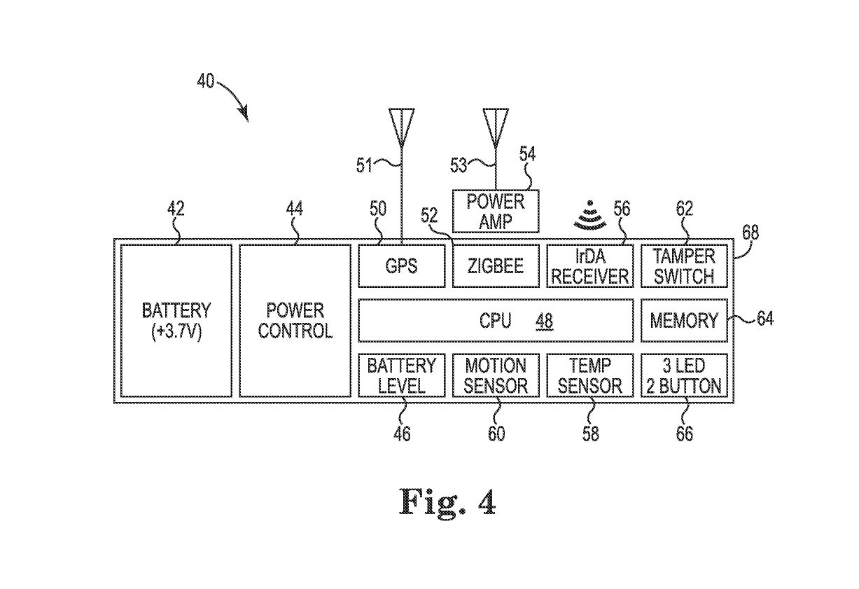

FIG. 2, is illustrated in FIG. 3. Universal controller 30 includes a conditioning circuit 32, a regulator circuit 34, an output regulator 36, and two energy converters, a DC/DC converter 38A and an AC/DC converter 38B. Conditioning circuit 32 manipulates incoming energy in such way that it meets the requirement of regulator circuit 24 and will be automatically adjusted by output regulator 36. Regulator circuit 36, which could also be called a controller, manages power generated by the energy harvester (e.g., primary energy source 22). Output regulator 36 provides optimum power to the wireless transmitting device. DC/DC converter 38A is for converting a direct current type of energy source (photovoltaic cell, for example) into DC power and AC/DC converter 38B is for converting an alternating current type of energy source (piezoelectric based mechanical vibration, for example) into a DC power. Thus, any photoelectric cell or harvester would be operably connected to DC/DC converter 38A, any thermal harvester (thermoelectric transducer or generator) would be operably connected to DC/DC converter 38A, any RF harvester would be operably connected to AC/DC converter 38B, and any piezoelectric element would be operably connected to AC/DC converter 38B.

In one embodiment, all of the energy sources providing energy to AC/DC converter 38B are connected to the input of a single AC/DC converter 38B, which selectively and operationally connects to one of the energy sources based on input from controller 30. In other embodiments, some or all of the energy sources have their own rectification or conversion circuitry; synchronous rectification or converter circuitry may be used to reduce losses. Further, multiple energy source inputs may utilize the same rectification or converter circuitry or portions of the same circuitry. The use of separate converter circuitry for each energy source is tailored specifically to each energy source and helps to prevent losses during the conversion from AC power to DC power. Other converter circuitry, such as synchronous rectification circuitry, could also be used.

In some embodiments, multiple energy inputs share at least one element of a converter and a sensing circuit, e.g., the sensing circuit can be s implied form of regulator circuit 34. The sensing circuit provides a simple mechanism to elect which of the energy inputs should be used to provide power to the load of the wireless node device. Additionally or alternately, the sensing circuit can determine whether multiple or all energy inputs can be used (e.g., in parallel) or if the energy use can be divided (e.g., some of the energy will directly power the load, while other will charge the battery, etc.).

Also in some embodiments, at least some of the energy inputs share at least one element of a converter, and also share a controller, such as controller 30. The term ‘controller’ is used loosely in this discussion; a controller could be, for example, a simple sensing circuit, a programmable digital circuit, regulator circuit 34, or a combination of regulator circuit 34 and output regulator 36. The controller, be it controller 30 or other, can be programmed to manage the multiple energy inputs by deciding which, if any, of the energy inputs should be used to provide power to the load of the wireless node device. For example, a preset priority to resolve conflicts when power is available on multiple energy inputs may be utilized. In other embodiments, the priority could be a ranking of the energy based on any number of factors like performance, efficiency and range. The priority scheme can be based on a set of criteria, where the energy input with the most available power is selected to provide power to the wireless device and other device circuitry until the various decisions regarding the energy inputs can be determined.

The controller may consider a variety of factors in making the decision, such as one or more of the characteristics of the power or energy present on each input. It may also consider the power state and load to provide power and charging options. The controller may be programmed to determine which power input will have, for example, the best efficiency or highest charge capability, and may decide to use several energy harvesting inputs or a selected source. Further, the controller may cooperate with a power management system of the wireless node device in the management decisions.

Multiple energy inputs may provide power simultaneously or at different points in time. Where there is a single energy input present at a particular point in time, the wireless node device may utilize that energy input to power the load of the wireless node device or to charge the battery. Where there are multiple energy inputs available, the controller determines the appropriate energy input to utilize or manages each system respectively. For example, looking at FIG. 2 again, the power management circuit or energy management circuit 28 may instruct primary energy source 24 or other energy source associated with the unused energy to send energy or power to the secondary reservoir system 26 to save the amount of power being wirelessly transmitted and wasted.

A multi-source energy harvesting power system of this disclosure is particularly adapted to be used for powering a wireless node device in a tracking system. A tracking system includes a wireless tracking device or transmitter device that has the capability to actively transmit and/or provide interactive information to a receiver located remote from the asset being tracked and transmitter device that is positioned in or on the asset. In some embodiments, the transmitter device is an active tag (e.g., an RF tag), having the capability to actively transmit and/or provide interactive information to the receiver, which is operably connected to a computer or display. The tracking system uses an established wireless communication network to identify the location of the transmitter device and convey that information in a useful manner, such as to the display. Examples of wireless RF communication networks with which the tracking system can function include ZigBee, (Low Energy) BlueTooth (LBT), WiFi (sometimes referred to as WLAN), LTE, and WiMax. Examples of wireless cellular communication networks with which the tracking system can function include CDMA, GSM, CDMA/GSM, from 2G to 4G LTE.

FIG. 4 illustrates a transmitter device 40 that utilizes a multi-source energy harvesting power system, in this particular embodiment, a hybrid energy control system with a primary energy (harvested energy) source and a secondary energy (stored energy) source. The control system also includes a controller, such as controller 30 of FIG. 3, to regulate the energy among the various sources within the system. As seen in FIG. 4, device 40 includes an energy control system 42, that is the hybrid multi-source energy harvesting system, and a battery 44 as back-up or reserve power.

Energy control system 42 provides an unlimited, although variable, energy source for device 40 by harvesting energy from ambient conditions such as UV light, vibration, temperature, etc. Preferably, the harvesting system 42 utilizes at least two different energy harvesting sources. System 42 includes a harvester and appropriate circuitry for each energy source, although in some embodiments the circuitry may be wholly or partially shared. Energy control system 42 also provides an uninterrupted energy supply for device 40 by providing a reservoir, such as a capacitor, for the harvested energy. Together, system 42 provides an unlimited and uninterrupted energy supply to device 40.

As a back-up to system 42, device 40 includes battery 44, which may be a rechargeable battery. In some embodiments, battery 44 is a small, thin, flexible, solid-state and near loss-less energy storage battery. Self-discharge or leakage from this rechargeable battery should be low and insignificant, so that energy can be reliably stored for decades on a single charge. Multiple rechargeable batteries 44 can be stacked vertically in a parallel configuration for more power and capacity without consuming additional system footprint. Other types of batteries, such as NiCad, lithium, lithium-ion, zinc-carbon, and alkaline batteries, could be used. In FIG. 4, battery 44 is identified as a 3.7V battery, although it is understood that other voltage batteries could be used. Electrically connected to battery 44 is a battery level monitor 46, which in turn is operably connected to a computer chip or CPU 48.

Transmitter device 40 also includes a positioning element, in this embodiment a GPS positioning element 50 connected to an antenna 51, which may be an internal antenna or an external antenna. Positioning element 50 provides data to transmitter device 40 regarding its physical location. In some embodiments, transmitter device 40 has two-way communication with the receiver. That is, transmitter device 40 transmits information (e.g., location) and also receives information from the receiver. For example, transmitter device 40 receives instructions, such as to acknowledge that device 40 is active and ready and to transmit the location information. Having received those instructions, device 40 can send back to the receiver acknowledgement that the communication was received and acted on. Device 40 is illustrated with a ZigBee communication module 52, configured to connect to the receiver via a ZigBee network. Module 52 includes an antenna 53, which may optionally include a power amplifier 54 to extend the range of the signal from module 52. It is module 52 that provides the communication basis for transmitter device 40 to the receiver.

Alternate embodiments of device 40 can include a CDMA (Code Divisional Multiple Access) and/or GSM (Global System for Mobile Communication) module, configured to connect to the receiver via either a CDMA or GSM cellular network. Yet other alternate embodiments of transmitter device 40 can include both a ZigBee module 52 and a CDMA and/or GSM module, or a ZigBee/LBT module.

Additionally, transmitter device 40 may include a data receiver 56, such as an infra red data link (IrDA), to provide a second communication means to device 40, as an alternate or back-up to module 52. IrDA 56 includes an optical window formed from an IR transparent material, such as glass, to allow infra red radiation or energy to pass to and from IrDA 56.

In the illustrated embodiment of device 40, any number of gauges and sensors may be included to indicate any number of problems or malfunctions, such as low battery level, overheating (as sensed by temperature sensor 58), unauthorized movement (as sensed by motion sensor 60), or tampering with device 40 (as sensed by switch 62). Any of the data or information regarding device 40, such as its position as determined by positioning element 50, alarm information, battery level information, and ping information, etc., can be stored in memory 64 of device 40, which may be a permanent memory or a rewritable memory. Device 40 also includes various operational switches and buttons 66, in this embodiment, 3 LED lights and 2 buttons.

The various elements that compose transmitter device 40 may be enclosed (e.g., housed, encased, surrounded) at least partially (and preferably completely) in a case or container 68 that is substantially transparent to RF signals, so that RF signals may readily pass through the enclosure.

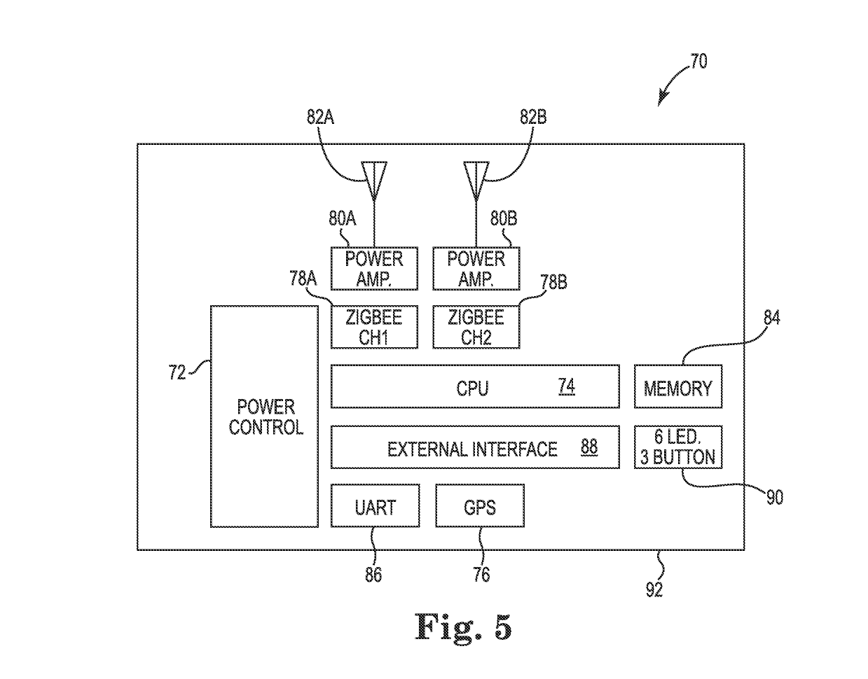

FIG. 5 illustrates another embodiment of a transmitter device that utilizes a multi-source energy harvesting power system. Unlike transmitter device 40 however, transmitter device 70 includes no battery back-up, but merely has a hybrid, multi-source energy harvesting system 72, which is operably connected to a computer chip or CPU 74. Energy system 72 provides an unlimited, uninterrupted energy source for device 70 by harvesting energy from at least two different energy harvesting sources and storing that energy.

Similar to transmitter device 40, device 70 also includes a positioning element, in this embodiment a GPS positioning element 76 that provides data to transmitter device 70 regarding its physical location. Device 70 is a multiple channel transmitter with two ZigBee communication modules 78A, 78B, configured to connect to the receiver via a ZigBee network via two distinct channels. Each module 78A, 78B includes an antenna 82A, 82B, which may be an internal or an external antenna, and includes a power amplifier 80A, 80B to extend the range of the signal from module 78A, 78B. Device 70 also includes a UART (universal asynchronous receiver/transmitter) 86.

Data from GPS 76 can be stored in memory 84 of device 70, which may be a permanent memory or a rewritable memory. An external interface 88 may be present to display the data or to receive manually inputted instructions. Device 70 also includes various operational switches and buttons 90, in this embodiment, 6 LED lights and 3 buttons. The device, in some embodiments, conforms to RS 323 standards (e.g., RS 323C). The various elements that compose transmitter device 70 are enclosed (e.g., housed, encased, surrounded) in a case or container 92 that is substantially transparent to RF signals.

The effectiveness of the tracking system to track and/or locate the asset is directly impacted by the life of the power source (i.e., battery or power control system) that provides transmitter device 40, 70 with the energy to perform its function, which includes sending its ‘ping’. The expectation with these tracking systems, and particularly transmitter device 40, 70, is to have autonomous operation for extended periods of time, such as weeks, months, and sometimes even years. An active RF tag or transmitter device 40, 70 actively transmits its location or other data at a predetermined point in time to the receiver. Although each data transmission or ping from transmitter device 40, 70 uses very little power from the self-contained battery, over extended periods of time, such as days, weeks, and sometimes even months, the battery is drained of power, resulting in a poorly functioning or non-functioning transmitter which could result in a lost tagged asset. The power control systems of this disclosure provide a long time, extended use power source that can reliably store energy for years or decades on a single charge.

The tracking systems themselves may be designed to reduce the amount of power used to extend the battery life. Many tracking systems utilize a time-based ping, where a data ping is sent from the transmitter device to the receiver every predetermined interval. Advances have been made in optimizing the value per ping by sending a ping when needed and not during times of inactivity. For example, U.S. patent applications having Ser. Nos. 13/796,574 and 13/796,683, both filed Mar. 12, 2013, and U.S. patent application having Ser. No. 13/845,802 filed Mar. 18, 2013, all assigned to Petari USA, Inc. and all incorporated herein by reference, base the ping transmission on a predetermined event and/or on detection of a predetermined movement or pattern of movement. Utilizing the power control systems of this disclosure, which utilize at least two primary energy harvesting sources and a secondary energy reservoir, together with the tracking systems of the above-identified patent applications can provide power for the tracking devices for decades.

Thus, embodiments of the WIRELESS DEVICE WITH HYBRID ENERGY CHARGING are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A wireless tracking device comprising:
a hybrid energy control system comprising a primary energy source, a secondary energy source, and an energy management controller operably connected to the primary energy source and the secondary energy source;
an RF communication module; and
a GPS positioning element.

2. The device of claim 1 further comprising a battery.

3. The device of claim 1 wherein the primary energy source comprises at least two energy harvesters and appropriate circuitry.

4. The device of claim 3 wherein the at least two energy harvesters are selected from a piezoelectric element, a photovoltaic cell, and a thermoelectric generator.

5. The device of claim 3 wherein the at least two energy harvesters are individually selected from a piezoelectric element, a photovoltaic cell, and a thermoelectric generator.

6. The device of claim 1 wherein the communication module is a ZigBee, LTE, and/or Low Energy BlueTooth communication module.

7. The device of claim 1 further comprising a cellular communication module.

8. The device of claim 7 wherein the cellular communication module is a CDMA and/or GSM communication module.

9. The device of claim 1 wherein the energy management controller comprises a DC/DC converter or an AC/DC converter.

10. The device of claim 1 wherein the energy management controller comprises a DC/DC converter and an AC/DC converter.

11. A wireless tracking device comprising:
a hybrid energy control system comprising a first energy harvester, a second energy harvester, an energy reservoir operably connected to the first energy harvester and the second energy harvester, and an energy management controller operably connected to the first energy harvester, the second energy harvester, and to the reservoir;
an RF communication module; and
a GPS positioning element.

12. The device of claim 11 wherein the first energy harvester and the second energy harvester are individually selected from a piezoelectric element, a photovoltaic cell, and a thermoelectric generator.

13. The device of claim 11 wherein the RF communication module is a ZigBee, LTE, and/or Low Energy BlueTooth communication module.

14. The device of claim 11 further comprising a cellular communication module.

15. The device of claim 14 wherein the cellular communication module is a CDMA and/or GSM communication module.

16. The device of claim 11 wherein the energy management controller comprises a DC/DC converter and an AC/DC converter.

17. The device of claim 11 further comprising a battery.
